(19) United States
(12) Patent Application Publication
(10) Pub. No.: US 2009/0136343 A1
(43) Pub. Date: May 28, 2009

(54) Torque converter with weld contamination control ring

(75) Inventors: Nathan Yensho, Wooster, OH (US); Kerry Griffin, Wadsworth, OH (US); Steven Olsen, Wooster, OH (US)

Correspondence Address: Davidson, Davidson & Kappel, LLC, 485 7th Avenue, 14th Floor, New York, NY, 10018, US

(73) Assignee: LuK Lamellen und Kupplungsbau Beteiligungs KG, Buehl (DE)

(21) Appl. No.: 12/291,600

(22) Filed: Nov. 12, 2008

Related U.S. Application Data
(60) Provisional application No. 61/003,104, filed on Nov. 14, 2007.

(51) Int. Cl. F16H 41/24; B23P 11/00

(52) U.S. Cl. 415/215.1; 29/889.5

(57) ABSTRACT

A torque converter including an input housing having an axial surface and a pump shell having an axial surface. The input housing and the pump shell being welded together and the pump shell or the input housing having a groove facing the other of the pump shell or output housing. The torque converter also including a ring located in the groove and contacting the other of the pump shell or input housing.

Priority to U.S. Provisional Patent Application Ser. No. 61/003,104, filed Nov. 14, 2007, is claimed, the entire disclosure of which is hereby incorporated by reference herein.

The present invention relates generally to weld contamination within torque converters and a control ring to eliminate the weld contamination.

### BACKGROUND

Contamination generated from the enclosure weld process has been an issue because this weld aggregate causes excessive wear on the internal components of the torque converter and to the transmission.

Isolating weld contamination while joining components during a weld process is accomplished by bottoming the two components together, commonly referred to as Select-Fit. This requires the addition of shims to reduce axial movement of the internal components.

U.S. Pat. No. 4,867,641, hereby incorporated by reference herein, describes a weld process in which the two components are bottomed together and forming a radial space for collecting the welding spatter.

Contamination inside torque converters that have been welded is hard to eliminate with current machining tolerances and processes. Select-Fit reduces contamination from enclosure welding but is costly because it adds additional components and processes to torque converter manufacturing. Flushing the final assembly after it has been welded together is time consuming, costly and requires substantial capital investment and adds additional space for final assembly.

### SUMMARY OF THE INVENTION

The present invention provides a torque converter including an input housing having an axial surface and a pump shell having an axial surface, input housing and the pump shell being welded together. The pump shell or the input housing having a groove facing the other of the pump shell or output housing and a ring located in the groove and contacting the other of the pump shell or input housing.

By using the ring, parts may be built with less complex processes. Using the weld control ring also helps to eliminate enclosure weld contamination.

### BRIEF DESCRIPTION OF THE DRAWINGS

Further features and advantages of the invention will become apparent from the following detailed description taken in conjunction with the accompanying drawings, in which:

FIG. 1 illustrates a torque converter.

FIG. 2 illustrates a control ring according to the present invention prior to the welding.

FIG. 3 illustrates the weld control ring according to the present invention.

FIG. 4a and 4b illustrate the different possible connection ends for the ring.

### DETAILED DESCRIPTION

Another method for reducing weld contamination includes an integrated lip seal. The lip seal isolates contamination by having a machined feature that creates a seal and collects the weld contamination in the design.

Furthermore the integrated lip seal reduces contamination from enclosure weld, but is difficult to machine with current machining tolerances, needs a press in final assembly of the converter because it requires a large amount of force to fit and compress the lip seal and creates concentricity problems in final assembly.

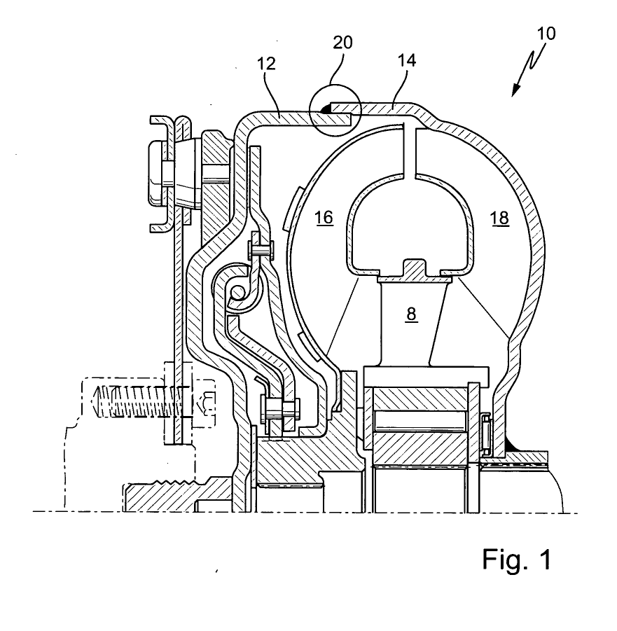

FIG. 1 describes a torque converter 10 according to the present invention, having an input housing 12, a turbine 16, a stator housing 8, a pump 18 and a pump shell 14. The ends of input housing 12 and pump shell 14 are fitted together and welded at location 20.

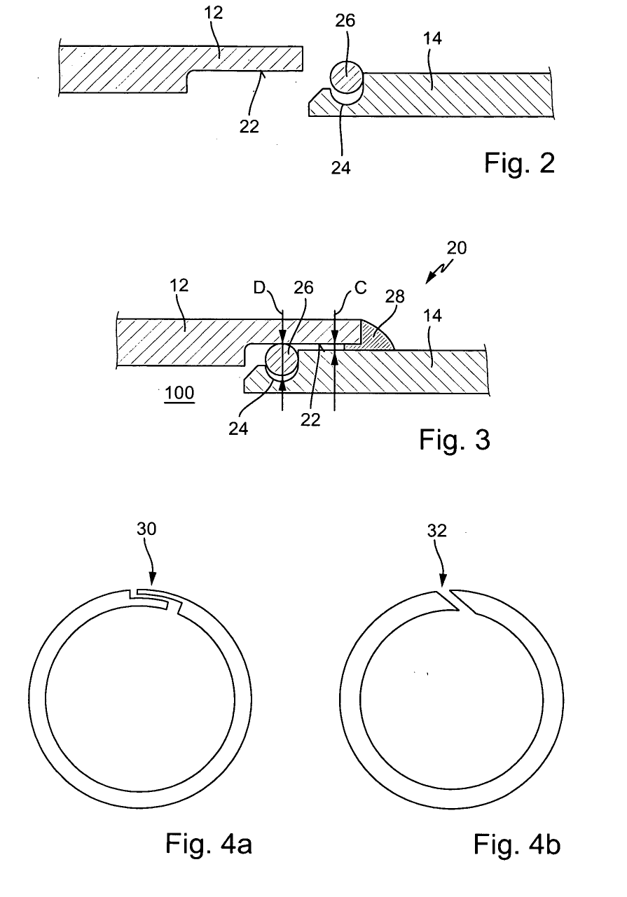

FIG. 2 illustrates the torque converter weld connection using a control ring according to the present invention, prior to the weld. Input housing 12 has an axial surface 22. Pump shell 14 contains a machined groove 24. During the assembly of the torque converter 10, an additional component, a compressible ring 26, for example made of metal spring wire, is included. Ring 26 is contained in machine groove 24. The overall diameter of ring 26 before compression is greater than the overall inside diameter of axial surface 22. Ring 26 then during assembly will compress radially to create a permanent seal with mating axial surface 22, isolating the weld contamination and preventing it to pass ring 26 and travel into the torque converter. In order to allow ring 26 to compress, the weld contamination control ring is an extra component in the converter.

FIG. 3 illustrates the torque converter area with a control ring according to the present invention after welding. Input housing 12 and pump shell 14 are welded together at a weld 28, shown schematically, ring 26 is in machine groove 24 and contacts axial surface 22. Ring 26 can prevent contamination in under arc 100 or torque converter 20.

FIGS. 4a and 4b illustrate the connection of the ring. Ring 26 has a circumferential opening. In order for ring 26 to compress, part is left open. To prevent contamination, from entering the circumferential opening, the ends of ring 26 are then connected with stepped ends 30 (FIG. 4a) or tapered ends 32 (FIG. 4b).

In the current design, ring 26 is preferably made from metal such as spring wire material, but any material may be used as long as it is free to compress into the machined groove and survive the weld process. Most rubber and plastics typically should not be used as the heat from the weld may melt the ring.

The weld contamination control ring creates a seal that eliminates the need for the final welded converters to be flush, the need for a large press in the final assembly to assemble the integrated lip seal, or extra processes to assemble the Select Fit converter. The contact pressure between ring 26 and converter 10 can be controlled by material, thickness and the amount of the ring material that will radially deform. The weld contamination will be contained between weld contamination control ring and the weld.

Pump shell 14 can be manufactured within a tolerance C of housing 12. Ring 26 can be selected to have a diameter or radial extent D (if not cylindrical), larger than tolerance C, and preferably a radius, larger than tolerance C.

What is claimed is:

1. A torque converter comprising:
an input housing having an axial surface;
a pump shell having an axial surface, the input housing and the pump shell being welded together; the pump shell or the input housing having a groove facing the other of the pump shell or output housing; and
a ring located in the groove and contacting the other of the pump shell or input housing.

2. The torque converter as recited in claim 1 wherein the ring has a circumferential opening permitting compression.

3. The torque converter as recited in claim 2 wherein the circumferential opening of the ring has tapered ends.

4. The torque converter as recited in claim 2 wherein the circumferential opening of the ring has stepped ends.

5. The torque converter as recited in claim 1 wherein the ring is a wire ring.

6. The torque converter as recited in claim 5 wherein the ring is a spring wire.

7. The torque converter as recited in claim 1 wherein the ring is a metal ring.

8. The torque converter as recited in claim 1 wherein the ring is compressible.

9. The torque converter as recited in claim 1 wherein the ring has a radial extent greater than the manufactured tolerance between the pump shell and the input housing.

10. A method for manufacturing a torque converter comprising:
welding an input housing to a pump shell; and
prior to the welding, providing a ring between an input housing and a pump shell to prevent contamination into an inside of the torque converter.

11. The method for manufacturing a torque converter as recited in claim 10 further comprising compressing the ring when the housing and shell are assembled.
